(19) United States
(12) Patent Application Publication
(10) Pub. No.: US 2009/0251602 A1
(43) Pub. Date: Oct. 8, 2009

(54) System and Method for Providing Video and Audio Signals to Multiple Displays

(75) Inventors: David Williams, Canton, GA (US); William Dunn, Alpharetta, GA (US); Gerald Fraschilla, Snellville, GA (US)

Correspondence Address: STANDLEY LAW GROUP LLP, 6300 Riverside Drive, Dublin, OH, 43017, US

(73) Assignee: Manufacturing Resources International, Inc., Alpharetta, GA (US)

(21) Appl. No.: 12/418,250

(22) Filed: Apr. 3, 2009

Related U.S. Application Data
(60) Provisional application No. 61/042,145, filed on Apr. 3, 2008.

(51) Int. Cl. H04N 5/06

(52) U.S. Cl. 348/521; 348/E05.011

(57) ABSTRACT

A system and method for providing digital AV signal to multiple displays where the digital AV signal is displayed simultaneously and sychronized. Exemplary embodiments utilize serializers, de-serializers, and clock cleaners to transmit the data to a chain of display nodes. The display nodes convert the serial data stream into a parallel data stream. The parallel data stream is de-jittered and used to drive a display and optional audio system. The parallel data stream is then converted back into a serial data stream and sent to the next display node in the chain. A clock present in the data stream allows synchronization of all the displays in the chain. A distribution display node may be used at any display node location to increase the number of chains in the data delivery system.

### CROSS-REFERENCE TO RELATED APPLICATIONS

This application is a non-provisional patent application and claims priority to U.S. Provisional Application No. 61/042,145 filed Apr. 3, 2008, which is hereby incorporated by reference as if fully rewritten herein.

### TECHNICAL FIELD

Exemplary embodiments relate to a method of providing video and audio signal to multiple displays. More particularly, exemplary embodiments relate to a method of providing digital signal to multiply displays in a daisy chain configuration.

### BACKGROUND AND SUMMARY OF THE INVENTION

It is often desirable to be able to display a single video and audio stream onto multiple displays simultaneously. Examples of this can be found in displays mounted throughout airport terminals and gas stations having a display located at every gas pump. In most cases, this often is accomplished by having a single video and audio server with multiple outputs to broadcast an analog video and audio stream. The analog video and audio stream is carried by coaxial cable to a string of multiple displays. Depending on the length between displays, the use of coaxial cable may require a boost to the analog video and audio signal several times due to loss of signal strength in the coaxial cable. In addition, the quality of the analog video and audio signal carried by the coaxial cable often deteriorates leading to ghosting of the image. Due to the cost associated with coaxial cable, image quality associated with an analog video signal, and the transition of CRT displays to LCD displays led to the use of digital video and audio signals.

In the display of a single video and audio stream on multiple displays, broadcasting the video and audio digitally is the preferred method for assuring the highest quality. Taken a step further, the quality of the video and audio stream can be enhanced even further by broadcasting an uncompressed video and audio stream since most compression algorithms often cause anomalies in the final, displayed image.

The exemplary embodiments provide an efficient and low cost method of providing a video and audio stream from a single source to multiple displays simultaneously. An exemplary embodiment takes advantage of current serializer/deserializer (“SerDes”) technology. This technology provides a means to convert a 24-bit parallel data input and clock to a single differential output (serializer) at the transmitter source. At the receiver, the clock and 24-bit data is recovered (deserializer). Coupling this technology with, for example, inexpensive CAT-5 cable to carry the digital video and audio signal between display nodes provides a means to transmit uncompressed digital audio and video.

To allow the multiple displays to display the video and audio stream simultaneously exemplary embodiments employ “daisy-chaining.” The concept of “daisy-chaining” utilizes SerDes and Cat-5 cable as an inexpensive and effective means to broadcast a digital video and audio stream to a serial string of displays. CAT-5 cable is typically comprised of four pairs of twisted wire. Therefore, depending on the bandwidth required, up to three of the four pairs of twisted wire may be used for transmitting digital video and the fourth pair for transmitting digital audio. At each display node, the video data from each twisted wire pair in the CAT-5 cable is received and re-synchronized to its recovered deserializer clock. One of the recovered clocks is also used as an input to a “clock cleaner” integrated circuit for the purpose of removing jitter. The clock cleaner outputs a de-jittered clock as well as a de-jittered multiplied clock. These clocks are then used to drive the display as well as clocking the serializers to drive the digital video and audio data to the next display node. By repeating this sequence at each display node, the ability to drive an infinite number of display nodes from a single digital video and audio source is achieved.

In another embodiment the string of serialized display nodes may move from a linear design to a branched design. This design can be accomplished by using one of the display nodes as a distribution display node with multiple outputs to drive other strings of serialized display nodes. The distribution and display node may be placed at any display node location. This embodiment may also cut the cost of the system by requiring fewer materials to accommodate a variety of display locations.

Other systems, methods, features and advantages of the invention will be, or will become apparent to one with skill in the art upon examination of the following figures and detailed description. It is intended that all such additional systems, methods, features, and advantages be included within this description and be within the scope of the invention.

### BRIEF DESCRIPTION OF THE DRAWINGS

The following description includes discussion of various figures having illustrations given by way of example of implementations of embodiments of the invention. The drawings should be understood by way of example, not by way of limitation.

FIG. 1 is a block diagram of a display node chain

FIG. 2 is a block diagram of a display node chain having a distribution node.

### DETAILED DESCRIPTION OF THE EXEMPLARY EMBODIMENT(S)

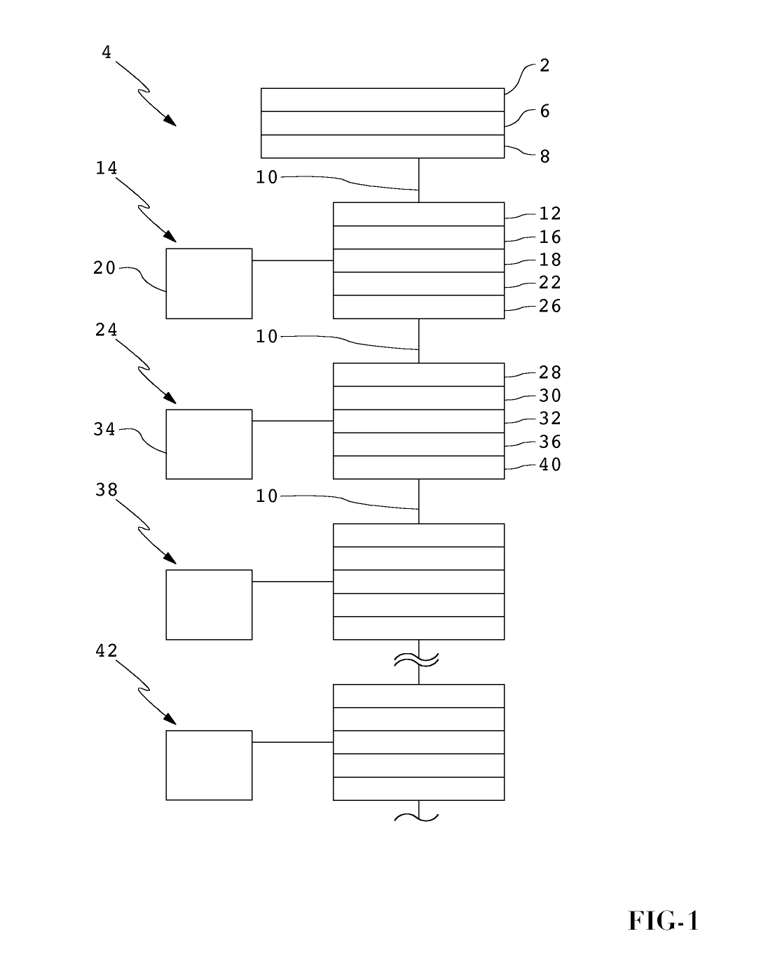

FIG. 1 is a block diagram of an exemplary embodiment to allow for a string of multiple displays from a single audio and video source. A single digital audio and video source 2 is used to send a signal to a first string of display nodes 4. The single digital audio and video source 2 may be a signal received from a satellite, over the air antennae, cable, stored media, or from any other source capable of supplying a digital audio and video signal. From the audio and video source 2 the digital signal is passed to serializer circuitry 6. The first serializer circuitry 6 converts the parallel data and clock from the signal produced by the digital audio and video source 2 to a single serial output. This serial signal is then transmitted by a first transmitter 8 as uncompressed digital audio and video.

The transmitted digital signal is carried from the transmitter 8 by a span of CAT-5 or CAT-6 cable or other suitable wired connection 10 to a first receiver circuitry 12 at a first display node 14. CAT-5 cable is typically comprised of 4 pairs of twisted wire. Therefore, depending on the bandwidth required, up to 3 of the 4 pairs could be used for transmitting digital video and the fourth pair for transmitting digital audio. Depending on the bandwidth, the wires of a CAT-5 cable could be used in any combination to carry the audio and video signal. The first receiver circuitry 12 receives the digital audio and video signal and passes the signal to a first deserializer circuitry 16. The first deserializer circuitry 16 recovers the clocks and the parallel data. One of the recovered clocks is used as an input to a first “clock cleaner” circuitry 18. The purpose of the first “clock cleaner” circuitry 18 is to remove jitter. This is accomplished when the first “clock cleaner” circuitry 18 outputs a de-jittered clock as well as a de-jittered multiplied clock. These clocks are then used to drive a first display 20 located at the first display node. The first display 20 can be LCD, OLED, or any other display capable of displaying digital signal. The recovered clocks from the first “clock cleaner” circuitry 18 are also used to clock a second serializer 22 to drive the digital audio and video signal to a second display node 24. The digital audio and video signal is sent to the second display node 24 by a second transmitter circuitry 26. The audio and video signal is carried from the second transmitter circuitry 26 to the second display node 24 by CAT-5 cable 10.

At the second display node 24 the same signal processing found in the first display node 14 is repeated. The digital audio and video signal is received by a second receiving circuitry 28 from the CAT-5 cable 10. A second deserializer circuitry 30 recovers the clocks and the parallel data. One of the recovered clocks is used as an input to a second “clock cleaner” circuitry 32. The purpose of the second “clock cleaner” circuitry 32 is the same as the first “clock cleaner” circuitry 18. The second “clock cleaner” circuitry 32 removes jitter by outputting a de-jittered clock as well as a de-jittered multiplied clock. These clocks are then used to drive a second display 34. Like the first display 20, the second display 34 may be LCD, OLED, or any other type of display capable of displaying a digital signal. The recovered clocks from the second “clock circuitry” 32 are also used to clock a third serializer 36 to drive the digital audio and video signal to a third display node 38. The digital audio and video signal is sent to the third display node 38 by a third transmitter circuitry 40. The audio and video signal is carried from the third transmitter circuitry 40 to the third display node 38 by CAT-5 cable 10.

In the current embodiment of the present invention this process may be repeated to provide audio and video signal to an essentially unlimited number of nodes 42 (expressed as variable “n”). The signal is repeatedly sent to additional display nodes where the steps above are repeated. In this method the displays at each display nodes are synchronized. In addition, there is no need to boost the signal due to signal loss associated with coaxial cable.

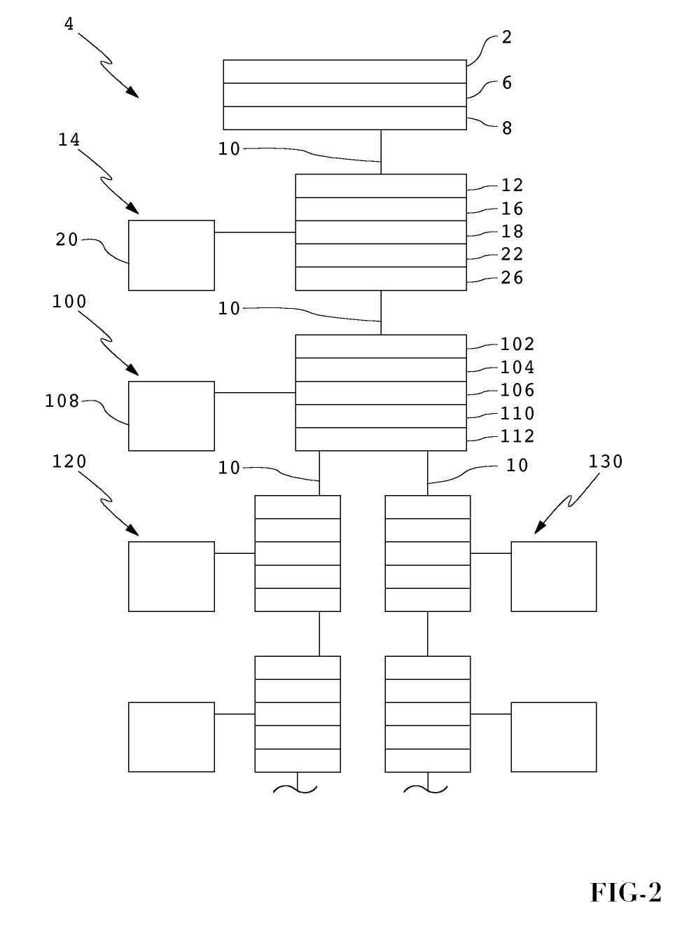

FIG. 2 is a block diagram illustrating another embodiment of the present invention. In this embodiment an audio and video signal is produced by a single digital audio and video source 2. The single digital audio and video source 2 may be a signal received from a satellite, over the air antennae, cable, stored media, or from any other source capable of supplying digital audio and video signal. From the audio and video source 2 the digital signal is passed to a first serializer circuitry 6. The first serializer circuitry 6 converts the parallel data and clock from the signal produced by the digital audio and video source 2 to a single differential output. This converted signal is then transmitted by a first transmitter 8 as uncompressed digital audio and video to the first string of displays 4.

The transmitted digital signal is carried from the first transmitter 8 by a run of CAT-5 cable 10 to a first receiver circuitry 12 at a first display node 14. The CAT-5 cable 10 is comprised of 4 pairs of twisted wire. Therefore, depending on the bandwidth required, up to 3 of the 4 pairs could be used for transmitting digital video and the fourth pair for transmitting digital audio. Depending on bandwidth, the wires of the CAT-5 cable could be used in any combination to carry the digital audio and video signal. The first receiver circuitry 12 receives the digital audio and video signal and passes the signal to first deserializer circuitry 16. The first deserializer circuitry 16 recovers the clocks and the parallel data. One of the recovered clocks is used as an input to a first “clock cleaner” circuitry 18. The purpose of the first “clock cleaner” circuitry 18 is to remove jitter. This is accomplished when the first “clock cleaner” circuitry 18 outputs a de-jittered clock as well as a de-jittered multiplied clock. These clocks are then used to drive a first display 20 located at the first display node 14. The first display 20 can be LCD, OLED, or any other display capable of displaying digital signal. The recovered clocks from the first “clock cleaner” circuitry 18 are also used to clock a second serializer 22 to drive the digital audio and video signal to a first distribution display node 100. The digital audio and video signal is sent to the first distribution display node 100 by a second transmitter circuitry 26. The audio and video signal is carried from the second transmitter circuitry 26 to the first distribution display node 100 by CAT-5 cable 10.

At the first distribution display node 100 the digital audio and video signal is received by the first distribution display node receiving circuitry 102 from the CAT-5 cable 10. A first distribution display node deserializer circuitry 104 recovers the clocks and the parallel data. One of the recovered clocks is used as an input to a first distribution display node “clock cleaner” circuitry 106. The first distribution display node “clock cleaner” circuitry 106 removes jitter by outputting a de-jittered clock as well as a de-jittered multiplied clock. These clocks are then used to drive a first distribution display node display 108. Like the first display 20, the first distribution display node display 108 may be LCD, OLED, or any other type of display capable of displaying a digital signal. The recovered clocks from the first distribution display node “clock circuitry” 106 are also used to clock a first distribution display node serializer 110 to drive the digital audio and video signal to a second display chain 120 and a third display chain 130. The digital audio and video signal is sent to a second display chain 120 and a third display chain 130 by a first distribution display node transmitter circuitry 112. To accomplish the transmittal to multiple strings of displays the first distribution display node transmitter circuitry 112 has multiple outputs. The audio and video signal is carried from the first distribution display node transmitter circuitry 112 to a second display chain 120 and a third display chain 130 by CAT-5 cable 10. The second display chain 120 and the third display chain 130 repeat the signal processing of the display chain found in FIG. 1. Each display chain may any number of nodes.

In this embodiment a distribution display node may send the digital audio and video signal to more than two additional display chains. In addition, the distribution display node may replace any node in a display chain where it is desired to have multiple outputs. In this manner the overall design of this method may be configured to accommodate any wiring needs.

In another exemplary embodiment, multiple distribution display nodes may also be employed in any of the display chains. This would exponentially increase the number of configurations that could be employed.

While various embodiments have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method of supplying a data stream to multiple displays comprising:
presenting a first parallel data stream;
converting the first parallel data stream into a first serial data stream;
transmitting said first serial data stream to a first display node wherein said first serial data stream is converted into a second parallel data stream;
displaying said second parallel data stream on a first display in communication with said first display node;
converting said second parallel data stream into a second serial data stream at the first display node;
transmitting said second serial data stream to a second display node wherein said second serial data stream is converted into a third parallel data stream;
displaying said third parallel data stream on a second display in communication with said second display node, wherein said second display is synchronized with said first display;
converting said third parallel data stream into a third serial data stream at the second display node; and
wherein the steps above are repeatable for an n number of display nodes, wherein n is a positive integer greater than or equal to two.

2. The method of claim 1, wherein all the data streams contain a means for synchronization.

3. The method of claim 2, wherein the means for synchronization is a clock.

4. The method of claim 3, further comprising the steps of:
de-jittering the data stream at each node using a clock cleaner.

5. The method of claim 1, wherein said serial data streams are carried by CAT-5 cable.

6. The method of claim 1, wherein any one of said display nodes is a distribution display node having multiple serial data stream outputs.

7. The method of claim 6, wherein said one or more distribution display nodes perform the additional step of:
transmitting said serial data stream to a plurality of display nodes.

8. A method of supplying a data stream to multiple displays comprising:
presenting a parallel data stream;
converting the parallel data stream to a serial data stream;
transmitting said first serial data stream to a chain of at least one display nodes, each display node performing the steps of:
converting the incoming serial data stream into a parallel data stream,
displaying the parallel data stream on a display in communication with the display node,
converting the parallel data stream back into a serial data stream; and
transmitting the serial data stream to the next display node.

9. The method of claim 8, further comprising the step of:
synchronizing the parallel and serial data streams at each display node.

10. The method of claim 9, wherein the step of synchronizing the data streams is performed by a clock device.

11. The method of claim 8, further comprising the step of:
de-jittering the serial and parallel data streams using a clock cleaning device.

12. The method of claim 8, wherein the transmitting step is performed by CAT-5 cable between each display node.

13. The method of claim 12, wherein said serial and parallel data streams are audio and video data.

14. The method of claim 8, wherein at least one of the display nodes is a distribution display node having a plurality of serial data stream outputs.

15. The method of claim 14, wherein said one or more distribution display nodes perform the additional step of:
transmitting said serial data stream to a plurality of display nodes.

16. A system for distributing data streams to a plurality of electronic displays, the system comprising:
a data source assembly comprising:
an AV signal source providing a parallel data stream,
a data source serializer which converts the parallel data stream into a serial data stream, and
a data source transmitter which transmits the serial data stream;
a first display node in electrical communication with the data source assembly and comprising:
a first node receiver which receives the serial data stream,
a first node de-serializer which converts the received serial data stream into a parallel data stream,
a first node display which displays the parallel data stream,
a first node serializer which converts the parallel data stream into a serial data stream, and
a first node transmitter which transmits the serial data stream; and
a second display node in electrical communication with the first display node and comprising:
a second node receiver which receives the serial data stream,
a second node de-serializer which converts the received serial data stream into a parallel data stream,
a second node display which displays the parallel data stream,
a second node serializer which converts the parallel data stream into a serial data stream, and
a second node transmitter which transmits the serial data stream.

17. The data stream distribution system of claim 16 further comprising:
N display nodes in electrical communication with the second display node wherein N is any positive integer.

18. The data stream distribution system of claim 17 wherein any one of the display nodes is a distribution display node having transmitter which simultaneously transmits the serial data stream to a plurality of additional display nodes.

19. The data stream distribution system of claim 16 further comprising:
a clock cleaner within each display node which synchronizes the displays of each display node.

20. The data stream distribution system of claim 19 wherein:
the transmission of each serial data stream takes place on CAT-5 cable.
